(19) United States
(12) Patent Application Publication
(10) Pub. No.: US 2026/0105077 A1
(43) Pub. Date: Apr. 16, 2026

(54) QUERYING MULTIPLE DATA SOURCES USING A KNOWLEDGE PROBABILITY GRAPH AND MACHINE LEARNING

(71) Applicant: INTERNATIONAL BUSINESS MACHINES CORPORATION, ARMONK, NY (US)

(72) Inventors: ZHONG FANG YUAN, XIAN (CN); TONG LIU, XIAN (CN); YUAN YUAN DING, SHANGHAI (CN); LI JUAN GAO, XIAN (CN)

(21) Appl. No.: 18/915,856

(22) Filed: Oct. 15, 2024

(51) Int. Cl. G06F 16/332; G06F 16/33

(52) U.S. Cl. CPC G06F 16/3329; G06F 16/334

(57) ABSTRACT

Querying multiple data sources using a knowledge probability graph and machine learning, includes: identifying, based on a request, one or more candidate subgraphs of a knowledge probability graph, wherein the knowledge probability graph describes data stored across a plurality of data sources; generating, by a large language model (LLM), one or more queries directed to a subset of the plurality of data sources corresponding to the one or more candidate subgraphs; and providing, in response to the request, data responsive to the one or more queries.

### BACKGROUND

The present disclosure relates to machine learning, database querying, data analysis, and managing heterogeneous data sources.

### SUMMARY

According to embodiments of the present disclosure, various methods, apparatus and products for querying multiple data sources using a knowledge probability graph and machine learning are described herein. In some aspects, querying multiple data sources using a knowledge probability graph and machine learning includes identifying, based on a request, one or more candidate subgraphs of a knowledge probability graph, wherein the knowledge probability graph describes data stored across multiple data sources; generating, by a machine learning model, one or more queries directed to a subset of the multiple data sources corresponding to the one or more candidate subgraphs, the machine learning model having been trained for natural language generative tasks; and providing, in response to the request, data responsive to the one or more queries, wherein the providing is based on a retrieval from the subset of the multiple data sources. In some aspects, a computer system comprising: one or more computer-readable storage media; a processor set; and program instructions stored on the one or more storage media to cause the processor set to perform operations comprising this method. In some aspects, a computer program product comprises: one or more computer-readable storage media; and program instructions stored on the one or more storage media to perform operations comprising this method.

### BRIEF DESCRIPTION OF THE DRAWINGS

FIG. 1 sets forth a block diagram of an example computing environment for querying multiple data sources using a knowledge probability graph and machine learning in accordance with some embodiments of the present disclosure.

FIG. 2 sets forth a flowchart of an example method for querying multiple data sources using a knowledge probability graph and machine learning in accordance with some embodiments of the present disclosure.

FIG. 3 sets forth a flowchart of another example method for querying multiple data sources using a knowledge probability graph and machine learning in accordance with some embodiments of the present disclosure.

FIG. 4 sets forth a flowchart of another example method for querying multiple data sources using a knowledge probability graph and machine learning in accordance with some embodiments of the present disclosure.

FIG. 5 sets forth a flowchart of another example method for querying multiple data sources using a knowledge probability graph and machine learning in accordance with some embodiments of the present disclosure.

FIG. 6 sets forth a flowchart of another example method for querying multiple data sources using a knowledge probability graph and machine learning in accordance with some embodiments of the present disclosure.

FIG. 7 sets forth a flowchart of another example method for querying multiple data sources using a knowledge probability graph and machine learning in accordance with some embodiments of the present disclosure.

FIG. 8 sets forth an example flow diagram for querying multiple data sources using a knowledge probability graph and machine learning in accordance with some embodiments of the present disclosure.

FIG. 9 sets forth an example user interface for generating summaries of data stored in a table in accordance with some embodiments of the present disclosure.

FIG. 10 sets forth an example diagram for calculating the semantic probability that data sources respectively represented by a pair of nodes are related to each other in accordance with some embodiments of the present disclosure.

FIG. 11 sets forth an example diagram for determining explicit scores for relationships between nodes of a knowledge probability graph in accordance with some embodiments of the present disclosure.

FIG. 12 sets forth an example diagram for determining implicit scores for relationships between nodes of a knowledge probability graph in accordance with some embodiments of the present disclosure.

FIG. 13 sets forth an example diagram of using chain of thoughts for a recall stage for querying multiple data sources using a knowledge probability graph and machine learning in accordance with some embodiments of the present disclosure.

FIG. 14 sets forth another example diagram of using chain of thoughts for a recall stage for querying multiple data sources using a knowledge probability graph and machine learning in accordance with some embodiments of the present disclosure.

FIG. 15 shows a diagram of an example diagram of an exact query stage for querying multiple data sources using a knowledge probability graph and machine learning in accordance with some embodiments of the present disclosure.

### DETAILED DESCRIPTION

In some aspects, a method of querying multiple data sources using a knowledge probability graph and machine learning may include: identifying, based on a request, one or more candidate subgraphs of a knowledge probability graph, wherein the knowledge probability graph describes data stored across multiple data sources; generating, by a machine learning model, one or more queries directed to a subset of the multiple data sources corresponding to the one or more candidate subgraphs, the machine learning model having been trained for natural language generative tasks; and providing, in response to the request, data responsive to the one or more queries, wherein the providing is based on a retrieval from the subset of the multiple data sources. This provides the technical advantage of identifying and querying multiple relevant data sources, increasing system utility and improving the overall user experience and quality of returned data.

In some aspects, the multiple data sources each comprise one or more atomic data sources and wherein the knowledge probability graph comprises multiple nodes each corresponding to a respective atomic data source of the multiple data sources. This provides the advantage of correlating atomic data sources to provide a more accurate grouping and correlation of accessible data.

In some aspects, identifying the one or more candidate subgraphs comprises: generating, by the machine learning model, a chain of thought for processing the request; generating, based on the chain of thought, a sequential graph; and identifying, from the knowledge probability graph, the one or more candidate subgraphs based on a graph structure matching applied to the sequential graph and a semantic matching applied to the sequential graph. This provides the technical advantage of leveraging an LLM to identify relevant data sources from the knowledge probability graph.

In some aspects, generating, by the machine learning model, the one or more queries comprises selecting one or more query generation models by the machine learning model. This provides the advantage of leveraging different specialized query generation models when querying multiple data sources.

In some aspects, the method further comprises: identifying, from the multiple data sources, multiple atomic data sources; and generating the knowledge probability graph, wherein the knowledge probability graph comprises: multiple nodes each corresponding to an atomic data source of the multiple atomic data sources, and multiple probability edges each connecting a respective pair of the multiple nodes. This provides the technical aspect of parsing or traversing atomic data sources to generate the knowledge probability graph, increasing overall performance and improving the user experience.

In some aspects, generating the knowledge probability graph comprises calculating, for each pair of nodes of the plurality of nodes, a probability edge value, wherein the probability edge value for a given pair of nodes is based on a semantic probability for the given pair of nodes and a logical probability for the given pair of nodes. This provides the technical advantage of using both semantic and logical relationships between data sources to determine their probability edge value, improving the quality of data correlation in the knowledge probability graph.

In some aspects, calculating the probability edge value comprises generating, by the machine learning model, based on first semantic information for a first node of the given pair of nodes and the second semantic information for the second node of the given pair of nodes, the semantic probability that the first node and the second node of the given pair of nodes are related to each other. This provides the advantage of leveraging semantic information generated by the LLM to evaluate how data sources may be related, improving the quality of data correlation in the knowledge probability graph.

In some aspects, calculating the probability edge value comprises calculating, based on first metadata for a first node of the given pair of nodes and second metadata for a second node of the given pair of nodes, the logical probability that the first node and the second node of the given pair of nodes are related to each other. This provides the advantage of leveraging metadata to evaluate how data sources may be related, improving the quality of data correlation in the knowledge probability graph.

In some aspects, the logical probability is based on an explicit relationship between the first metadata and the second metadata. This provides the advantage of leveraging explicit metadata relationships in evaluating how data sources may be related, improving the quality of data correlation in the knowledge probability graph.

In some aspects, the logical probability is based on an implicit relationship based on a semantic extension of the first metadata and another semantic extension of the second metadata. This provides the advantage of leveraging implicit metadata relationships in evaluating how data sources may be related, improving the quality of data correlation in the knowledge probability graph.

In some aspects, a computer system comprising: one or more computer-readable storage media; a processor set; and program instructions stored on the one or more storage media to cause the processor set to perform operations comprising: identifying, based on a request, one or more candidate subgraphs of a knowledge probability graph, wherein the knowledge probability graph describes data stored across multiple data sources; generating, by a machine learning model, one or more queries directed to a subset of the multiple data sources corresponding to the one or more candidate subgraphs, the machine learning model having been trained for natural language generative tasks; and providing, in response to the request, data responsive to the one or more queries, wherein the providing is based on a retrieval from the subset of the multiple data sources. This provides the technical advantage of identifying and querying multiple relevant data sources, increasing system utility and improving the overall user experience and quality of returned data.

In some aspects, the multiple data sources each comprise one or more atomic data sources and wherein the knowledge probability graph comprises multiple nodes each corresponding to a respective atomic data source of the multiple data sources. This provides the advantage of correlating atomic data sources to provide a more accurate grouping and correlation of accessible data.

In some aspects, identifying the one or more candidate subgraphs comprises: generating, by the machine learning model, a chain of thought for processing the request; generating, based on the chain of thought, a sequential graph; and identifying, from the knowledge probability graph, the one or more candidate subgraphs based on a graph structure matching applied to the sequential graph and a semantic matching applied to the sequential graph. This provides the technical advantage of leveraging an LLM to identify relevant data sources from the knowledge probability graph.

In some aspects, to generating, by the machine learning model, the one or more queries comprises selecting one or more query generation models by the machine learning model. This provides the advantage of leveraging different specialized query generation models when querying multiple data sources.

In some aspects, the operations further comprise: identifying, from the multiple data sources, multiple atomic data sources; and generating the knowledge probability graph, wherein the knowledge probability graph comprises: multiple nodes each corresponding to an atomic data source of the multiple atomic data sources, and multiple probability edges each connecting a respective pair of the multiple nodes. This provides the technical aspect of parsing or traversing atomic data sources to generate the knowledge probability graph, increasing overall performance and improving the user experience.

In some aspects, generating the knowledge probability graph comprises calculating, for each pair of nodes of the multiple nodes, a probability edge value indicating whether a first node and a second node of the pair of nodes are related to each other, wherein the probability edge value for a given pair of nodes is based on a semantic probability that the first node and the second node of the given pair of nodes are related to each other and a logical probability that the first node and the second node of the given pair of nodes are related to each other. This provides the technical advantage of using both semantic and logical relationships between data sources to determine their probability edge value, improving the quality of data correlation in the knowledge probability graph.

In some aspects, calculating the probability edge value comprises generating, by the machine learning model, based on first semantic information for a first node of the given pair of nodes and the second semantic information for the second node of the given pair of nodes, the semantic probability that the first node and the second node of the given pair of nodes are related to each other. This provides the advantage of leveraging semantic information generated by the LLM to evaluate how data sources may be related, improving the quality of data correlation in the knowledge probability graph.

In some aspects, calculating the probability edge value comprises calculating, based on first metadata for a first node of the given pair of nodes and second metadata for a second node of the given pair of nodes, the logical probability that the first node and the second node of the given pair of nodes are related to each other. This provides the advantage of leveraging metadata to evaluate how data sources may be related, improving the quality of data correlation in the knowledge probability graph.

In some aspects, the logical probability is based on an explicit relationship between the first metadata and the second metadata. This provides the advantage of leveraging explicit metadata relationships in evaluating how data sources may be related, improving the quality of data correlation in the knowledge probability graph.

In some aspects, the logical probability is based on an implicit relationship based on a semantic extension of the first metadata and another semantic extension of the second metadata. This provides the advantage of leveraging implicit metadata relationships in evaluating how data sources may be related, improving the quality of data correlation in the knowledge probability graph.

In some aspects, computer program product comprising: one or more computer-readable storage media; and program instructions stored on the one or more storage media to perform operations comprising: identifying, based on a request, one or more candidate subgraphs of a knowledge probability graph, wherein the knowledge probability graph describes data stored across multiple data sources; generating, by a machine learning model, one or more queries directed to a subset of the multiple data sources corresponding to the one or more candidate subgraphs, the machine learning model having been trained for natural language generative tasks; and providing, in response to the request, data responsive to the one or more queries, wherein the providing is based on a retrieval from the subset of the multiple data sources. This provides the technical advantage of identifying and querying multiple relevant data sources, increasing system utility and improving the overall user experience and quality of returned data.

Additionally or alternatively, an embodiment where identifying the one or more candidate subgraphs comprises: generating, by the LLM, a chain of thought for processing the request; generating, based on the chain of thought, a sequential graph; and identifying, from the knowledge probability graph, the one or more candidate subgraphs based on a graph structure matching applied to the sequential graph and a semantic matching applied to the sequential graph provides the technical advantage of using the chain of thought generated by an LLM when processing a natural language request as a basis for identifying candidate subgraphs corresponding to atomic data sources, providing for more accurate and relevant selections of data sources for querying.

Additionally or alternatively, an embodiment where generating the knowledge probability graph comprises calculating, for each pair of nodes of the plurality of nodes, a probability edge value, wherein the probability edge value for a given pair of nodes is based on a semantic probability for the given pair of nodes and a logical probability for the given pair of nodes provides the technical advantage of using both a combination of semantic aspects of a data source as well as their respective metadata to create a comprehensive expression of a degree to which data sources may be related.

Increases in the amount of data accessible have given rise to both increasing amounts of data available from a given data source and also the number of overall data sources. Moreover, this data may be heterogeneous across data sources, being stored in various formats, encoded across various types of media, and the like. This diversity of data sources makes cross-data source querying difficult. It is critical that accurate information is extracted from these data sources. Moreover, data correlation may need to be done in an intelligent way to get a more comprehensive perspective of the data.

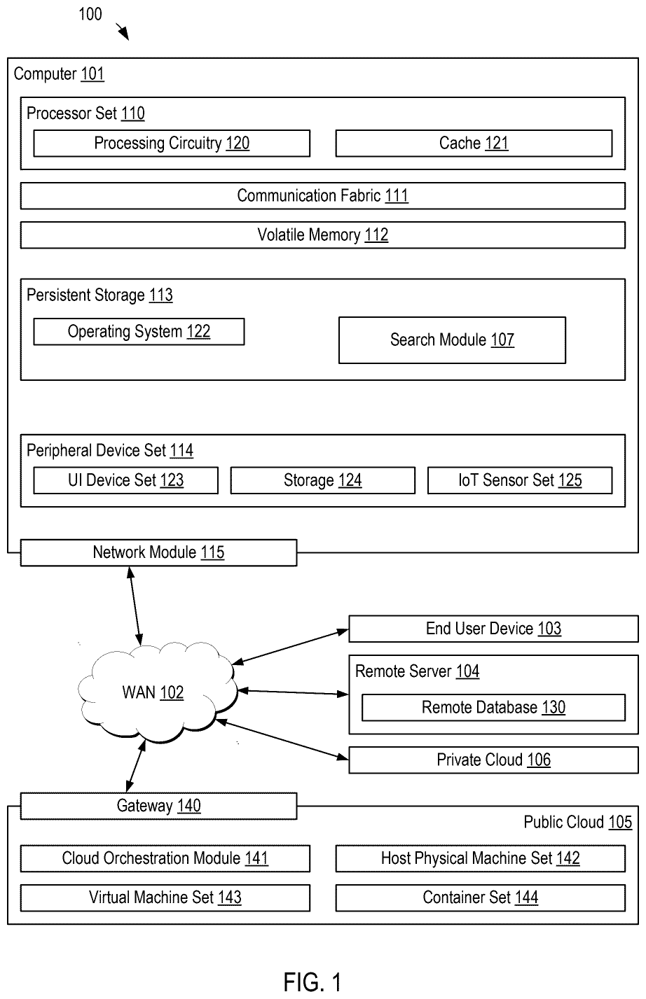

With reference now to FIG. 1, shown is an example computing environment according to aspects of the present disclosure. Computing environment 100 contains an example of an environment for the execution of at least some of the computer code involved in performing the various methods described herein, such as the search module 107. In addition to the search module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

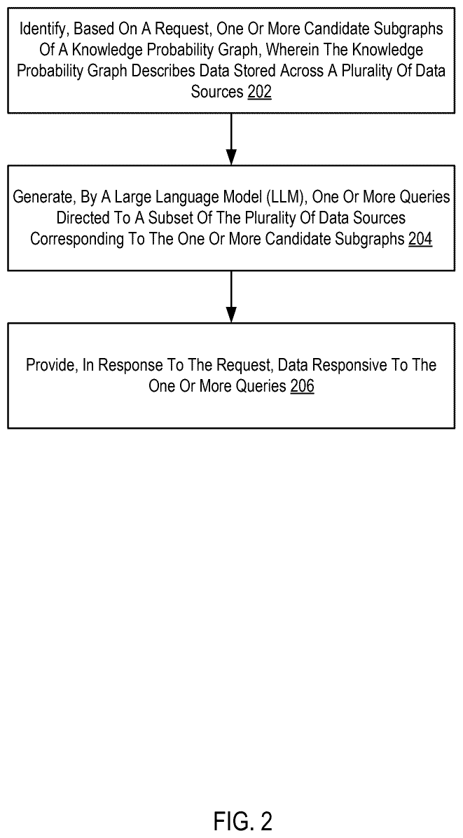

FIG. 2 sets forth a flowchart of an example method of querying multiple data sources using a knowledge probability graph and machine learning in accordance with some embodiments of the present disclosure. The method of FIG. 2 may be performed, for example, using the search module 107 of FIG. 1. The method of FIG. 2 includes identifying 202, based on a request, one or more candidate subgraphs of a knowledge probability graph. The knowledge probability graph describes data stored across a plurality of data sources. As described herein, a knowledge probability graph is a graph representation of a knowledge base (e.g., the plurality of data sources). Particular approaches for generating a knowledge probability graph are described in further detail below in subsequent flowcharts. Readers will appreciate that the approaches set forth herein for querying the multiple data sources using the knowledge probability graph includes a recall stage and an exact query stage. Here, identifying 202 the one or more candidate subgraphs of the knowledge probability graph corresponds to the recall stage.

In some embodiments, each node of the knowledge probability graph corresponds to a particular aspect or subcomponent of the plurality of data sources. In some embodiments, each of the data sources is composed of one or more atomic data sources. In other words, an atomic data source is an atomic subcomponent of a data source. In some embodiments, the plurality of data sources are heterogeneous data sources in that the data stored therein may be encoded, stored, and/or accessed using deferent methods, schema, formats, and the like. For example, the plurality of data sources may include file repositories, structured databases, and the like, with the data stored therein including database entries, unstructured or structured text data, audio data, visual data, audiovisual data, and/or other data as can be appreciated.

Accordingly, the particular atomic data sources for a given data source may vary depending on the nature or implementation of the given data source. For example, for a data source including a structured database, the atomic data sources of that structured database may include the tables of the structured database. As another example, for a Hadoop data store, the atomic data sources may include file blocks. Other atomic data sources are also contemplated within the scope of the present disclosure.

Accordingly, in some embodiments, each node of the knowledge probability graph may correspond to each atomic data source of the data sources. In other words, each atomic data source of the data sources may be represented in the knowledge probability graph by a corresponding node. Each node of the knowledge probability graph may include one or more features. In some embodiments, the one or more features may include field characteristics including or based on structured fields in the corresponding atomic data source, including metadata. In some embodiments, the one or more features may include semantic features including a textual summary of the corresponding atomic data source as generated by a large language model (LLM). In some embodiments, the one or more features may include the data itself stored in the corresponding atomic data source (e.g., “data traceability features”). Other features are also contemplated within the scope of the present disclosure.

The knowledge probability graph also includes a plurality of edges each linking a pair of nodes. In contrast to graph structures where an edge serves as a binary indicator of a relationship between two nodes (e.g., the nodes are connected if related and not connected if not related), the edges of the knowledge probability graph are represented by or correspond to a probability edge value indicating a probability that the nodes are related. For example, the probability edge value for a given pair of nodes may be represented as a continuous (e.g., floating point) value from zero to one.

The request may include a request for some data from or based on data stored in the plurality of data sources. The request may be embodied or encoded according to a variety of approaches. For example, in some embodiments, the request may include a natural language input describing the particular data to be provided in response to the request. The request may also be embodied according to other approaches, such as a structured query.

In some embodiments, the one or more candidate subgraphs are subgraphs of the knowledge probability graph identified or determined as being relevant or responsive to the request. In other words, the atomic data sources corresponding to the nodes of the candidate subgraphs are identified or determined to be relevant or responsive to the request. Accordingly, in some embodiments, identifying 202 the one or more candidate subgraphs may be based on a LLM processing the request and identifying 202, based on some output of the LLM, the one or more candidate subgraphs. Particular approaches for identifying 202 the candidate subgraphs using an LLM are described in further detail below.

The method of FIG. 2 also includes generating 204, by a LLM, one or more queries directed to a subset of the plurality of data sources corresponding to the one or more candidate subgraphs. Readers will appreciate that generating 204 and issuing these queries corresponds to the exact query stage described above. Although the approaches set forth herein are described with respect to a LLM, readers will appreciate that these approaches may also be implemented using another type of generative artificial intelligence (AI) model, trained machine learning model, and the like. The one or more queries are directed to a subset of the plurality of data sources in that the plurality of data sources are directed to the atomic data sources corresponding to the nodes of the one or more candidate subgraphs. For example, where a candidate subgraph includes nodes corresponding to a plurality of tables, the one or more queries may include one or more database queries targeting the plurality of tables.

In some embodiments, generating 204 the one or more queries may include the LLM itself generating the queries based on the request and the one or more candidate subgraphs. In some embodiments, as will be described in further detail below, generating 204 the one or more queries may include the LLM calling another model trained to convert some input (e.g., from the LLM) into queries of a particular different format.

The method of FIG. 2 also includes providing 206, in response to the request, data responsive to the one or more queries. For example, in some embodiments, the one or more queries may be issued to their respective data sources to access some data from the atomic data sources included in the candidate subgraphs. In some embodiments, this accessed data may be provided 206 in response to the request. As another example, in some embodiments, this accessed data (e.g., in aggregate or separately) may be summarized or otherwise processed by the LLM and the output of the LLM provided in response to the request.

The approaches set forth above leverage both an LLM and a knowledge probability graph to access data from multiple, heterogeneous data sources, improving the overall user experience. As will be described in further detail below, the LLM may be used to identify particular candidate subgraphs from the knowledge probability in order to narrow the scope of search for data responsive to a received request, increasing response time for servicing requests.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content—such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way. Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or create entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx.ai, which has become the generative AI backbone for other IBM products like watsonx Assistant and watsonx Orchestrate. In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to billions of parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a massive corpora of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they've acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants (like IBM watsonx Assistant and Google's BARD) to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

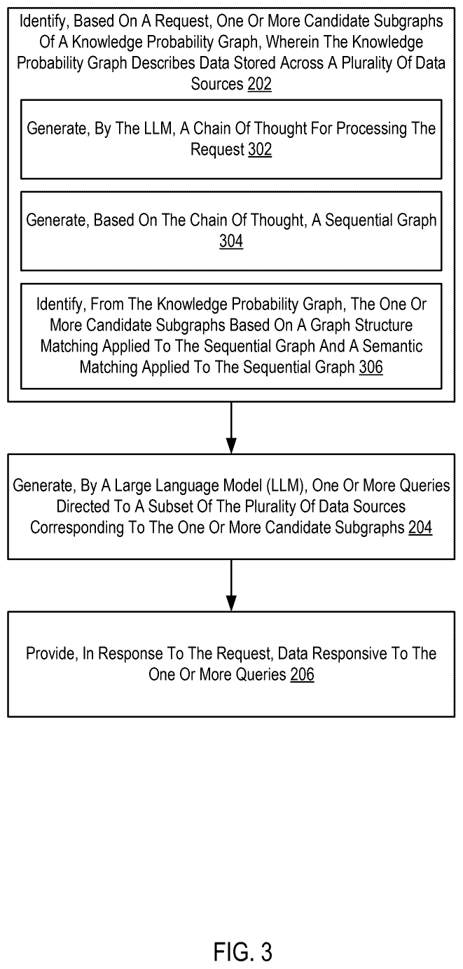

For further explanation, FIG. 3 sets forth a flowchart of an example method of querying multiple data sources using a knowledge probability graph and machine learning in accordance with some embodiments of the present disclosure. Particularly, the method of FIG. 3 describes particular embodiments for leveraging an LLM to identify candidate subgraphs from the knowledge probability graph. The method of FIG. 3 is similar to FIG. 2 in that the method of FIG. 3 also includes: identifying 202, based on a request, one or more candidate subgraphs of a knowledge probability graph, wherein the knowledge probability graph describes data stored across a plurality of data sources; generating 204, by a large language model (LLM), one or more queries directed to a subset of the plurality of data sources corresponding to the one or more candidate subgraphs; and providing 206, in response to the request, data responsive to the one or more queries.

The method of FIG. 3 differs from FIG. 2 in that identifying 202, based on a request, one or more candidate subgraphs of a knowledge probability graph also includes generating 302, by the LLM, a chain of thought for processing the request. A chain of thought is an output from the LLM that includes a step-by-step explanation of reasoning for how the LLM did or would process the request. The method of FIG. 3 also includes generating 304, based on the chain of thought, a sequential graph. The sequential graph is a graph representation of the chain of thought. Each node in the sequential graph corresponds to a step of the chain of thought. The sequential graph is sequential in that each node is connected only to a preceding node and a subsequent node, with the exception of the first and last node. For example, a first node corresponding to the first step in the chain of thought is connected to a second node corresponding to the second step. The second node is also connected to a third node corresponding to the third step, and so forth. Each node of the sequential graph may include a feature (e.g., as natural language text) describing the particular rationale or reasoning set forth by the LLM in the corresponding step. In some embodiments, the chain of thought includes at least two steps. In some embodiments, the chain of thought is produced by adding specific instructions in the prompt that is input into the LLM. The specific instructions request the LLM to provide a step-by-step reasoning for a conclusion. For example, the prompt explains a complex problem and the prompt concludes by stating “Calculate the total and explain your reasoning step by step”. In other instances, the prompt itself uses a phrase such as “perform Chain of Thought reasoning for your answer”.

Chain of thought (“CoT”) prompting is an approach in artificial intelligence that simulates human-like reasoning processes by delineating complex tasks into a sequence of logical steps towards a final resolution. This methodology offers a structured mechanism for problem-solving. CoT is predicated on the cognitive strategy of breaking down elaborate problems into manageable, intermediate thoughts that sequentially lead to a conclusive answer. CoT prompting goes beyond merely generating coherent and relevant responses and does so by requiring the AI to construct an entire logical argument, including premises and a conclusion, from scratch. While prompt chaining focuses on refining individual responses, CoT prompting aims to create a comprehensive and logically consistent argument, thereby pushing the boundaries of AI's problem-solving capability.

Consider if an AI is asked “What color is the sky?”, the AI would generate a simple and direct response, such as “The sky is blue.” However, if asked to explain why the sky is blue using CoT prompting, the AI would first define what “blue” means (a primary color), then deduce that the sky appears blue due to the absorption of other colors by the atmosphere. This response demonstrates the AI's ability to construct a logical argument.

Chain of thought prompting is carried out by leveraging large language models (LLMs) to articulate a succession of reasoning steps, guiding the model towards generating analogous reasoning chains for novel tasks. This is achieved through exemplar-based prompts that illustrate the reasoning process, thus enhancing the model's capacity for addressing complex reasoning challenges.

Chain of thought (CoT) prompting has evolved into various innovative variants, each tailored to address specific challenges and enhance the model's reasoning capabilities in unique ways. These adaptations not only extend the applicability of CoT across different domains but also refine the model's problem-solving process. These variants include zero-shot chain of thought, automatic chain of thought, and multimodal chain of thought.

The zero-shot chain of thought variant leverages the inherent knowledge within models to tackle problems without prior specific examples or fine-tuning for the task at hand. This approach is particularly valuable when dealing with novel or diverse problem types where tailored training data may not be available. This approach can leverage the properties of standard prompting and few-shot prompting.

For example, when addressing the question “What is the capital of a country that borders France and has a red and white flag?”, a model using zero-shot CoT would draw on its embedded geographic and flag knowledge to deduce steps leading to Switzerland as the answer, despite not being explicitly trained on such queries.

Automatic chain of thought (auto-CoT) aims to minimize the manual effort in crafting prompts by automating the generation and selection of effective reasoning paths. This variant enhances scalability and accessibility of CoT prompting for a broader range of tasks and users.

For example, to solve a math problem like “If you buy 5 apples and already have 3, how many do you have in total?”, an auto-CoT system could automatically generate intermediate steps, such as “Start with 3 apples” and “Add 5 apples to the existing 3,” culminating in “Total apples=8,” streamlining the reasoning process without human intervention.

Multimodal chain of thought extends the CoT framework to incorporate inputs from various modalities, such as text and images, enabling the model to process and integrate diverse types of information for complex reasoning tasks.

CoT prompting is a powerful technique for enhancing the performance of large language models (LLMs) on complex reasoning tasks, offering significant benefits in various domains such as improved accuracy, transparency, and multi-step reasoning abilities. CoT often requires high quality prompts to produce the desired output.

Users can benefit from a number of advantages within chain of thought prompting. Some of them include:
Improved prompt outputs: CoT prompting improves LLMs'performance on complex reasoning tasks by breaking them down into simpler, logical steps.
Transparency and understanding: The generation of intermediate reasoning steps offers transparency into how the model arrives at its conclusions, making the decision-making process more understandable for users.
Multi-step reasoning: By systematically tackling each component of a problem, CoT prompting often leads to more accurate and reliable answers, particularly in tasks requiring multi-step reasoning. Multi-step reasoning refers to the ability to perform complex logical operations by breaking them down into smaller, sequential steps. This cognitive skill is essential for solving intricate problems, making decisions, and understanding cause-and-effect relationships.
Attention to detail: The step-by-step explanation model is akin to teaching methods that encourage understanding through detailed breakdowns, making CoT prompting useful in educational contexts.
Diversity: CoT can be applied across a broad range of tasks, including but not limited to, arithmetic reasoning, commonsense reasoning, and complex problem-solving, demonstrating its flexible utility.

The evolution of chain of thought (CoT) production for language models is a testament to the synergistic advancements across several domains, notably in natural language processing (NLP), machine learning, and the burgeoning field of generative AI. These strides have not only propelled CoT into the forefront of complex problem-solving but also underscored its utility across a spectrum of applications.

CoT ability is in part based on ability of a language model to integrate symbolic reasoning tasks and logical reasoning tasks. This integration has improved models'capacity for abstract thinking and deduction, marking a significant leap in tackling logic-based challenges with CoT. For example, symbolic reasoning is solving mathematical equations, such as 2+3=5. In this case, the problem is broken down into its constituent parts (addition and numbers), and the model deduces the correct answer based on its learned knowledge and inference rules. Logical reasoning, on the other hand, involves drawing conclusions from premises or assumptions, such as “All birds can fly, and a penguin is a bird.” The model would then determine that a penguin can fly based on the provided information. The integration of CoT prompting into symbolic reasoning and logical reasoning tasks has allowed LLMs to demonstrate improved abstract thinking and deduction capabilities, enabling them to tackle more complex and diverse problems.

The application of generative AI and transformer architectures has revolutionized CoT, enabling the generation of sophisticated reasoning paths that exhibit creativity and depth. This synergy has broadened CoT's applicability, influencing both academic and practical domains.

Advances enabling smaller generative language machine learning models to effectively engage in CoT reasoning have democratized access to sophisticated reasoning capabilities. The focus on self-consistency within CoT ensures the logical soundness of generated paths, enhancing the reliability of conclusions drawn by models.

Chain of thought prompting signifies a leap forward in AI's capability to undertake complex reasoning tasks, emulating human cognitive processes. By elucidating intermediate reasoning steps, CoT not only amplifies LLMs' problem-solving acumen but also enhances transparency and interpretability. Ongoing explorations into CoT variants and applications continue to extend AI models' reasoning capacities, heralding future enhancements in AI's cognitive functionalities.

The method of FIG. 3 also includes identifying 306, from the knowledge probability graph, the one or more candidate subgraphs based on a graph structure matching applied to the sequential graph and a semantic matching applied to the sequential graph. In other words, the candidate subgraphs are identified from the knowledge probability graph using an algorithm that combines both graph structure matching and semantic matching, hereinafter referred to as a “hybrid search.” Graph structure matching compares the structure of the sequential graph to various subgraphs in the graph structure to determine a degree of similarity between the sequential graph and the compared subgraph. Semantic matching compares semantic features of the nodes of the sequential graph (e.g., the descriptions of the steps of the chain of thought) and the nodes of the compared subgraphs. In some embodiments, semantic matching includes embedding words of the nodes into a vector space such that synonyms and related concepts are closer to each other in the vector space as opposed to words and concepts that are unrelated to each other. Then a comparison such as a cosine similarity comparison is performed on the vectors to produce a numerical value representing the degree of semantic matching or not matching.

In some embodiments, graph structure matching and/or semantic matching may be used to generate scores or evaluations of various subgraphs in the knowledge probability graph. In some embodiments, the one or more candidate subgraphs may be selected as having a score or evaluation exceeding some threshold. In some embodiments, the one or more candidate subgraphs may be selected as the top N highest scoring subgraphs. Other approaches may also be used in selecting the candidate subgraphs.

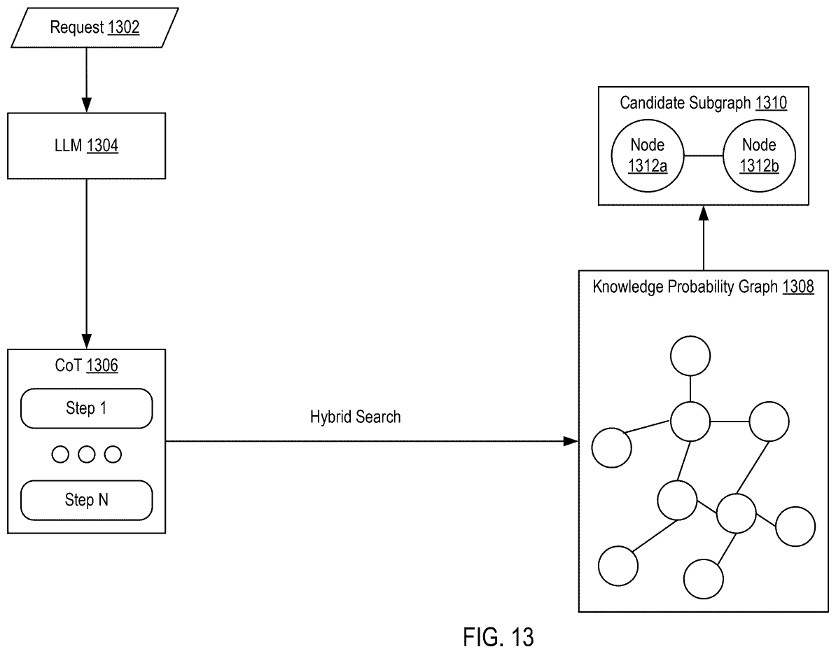

As an example, FIG. 13 shows a diagram of an example diagram of using chain of thoughts for a recall stage for querying multiple data sources using a knowledge probability graph and machine learning in accordance with some embodiments of the present disclosure. Here, the LLM 1304 receives a request 1302 for data from multiple data sources as described above. To process the request 1302, the LLM 1304 generates a chain of thought (CoT) 1306 explaining the rationale or approach of the LLM 1304 in processing the request. A graph encoding of this CoT 1306 is used to perform a hybrid search of a knowledge probability graph 1308. In other words, the CoT 1306 is used to identify a candidate subgraph 1310 including nodes 1312a, b from the knowledge probability graph 1308 based on graph structure matching and semantic matching.

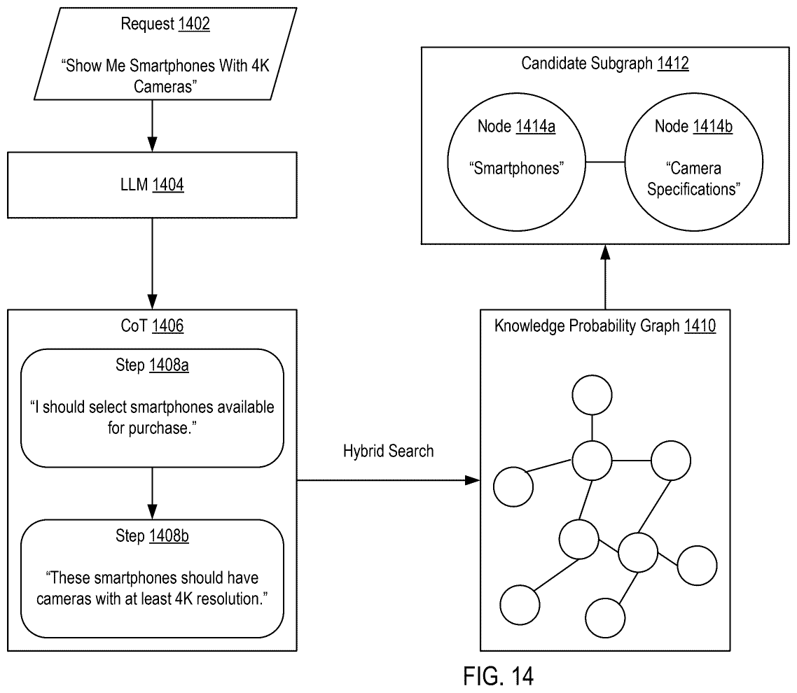

As another example, FIG. 14 shows a diagram of another example of using chain of thoughts for a recall stage for querying multiple data sources using a knowledge probability graph and machine learning in accordance with some embodiments of the present disclosure. In the example of FIG. 14, assume that a user wishes to find smartphones having cameras with 4K resolution using multiple data source querying. Here, a request 1402 is received including the natural language expression “Show me smartphones with 4K cameras. ” The LLM 1404 generates a chain of thought (CoT) 1406 for processing this request that includes two steps 1408a,b. Step 1408a includes the natural language expression “I should select smartphones available for purchase” and step 1408b includes the natural language expression “These smartphones should have cameras with at least 4K resolution.” These steps 1408a,b will be used to generate a sequential graph (e.g., step 1408a followed by and linked to step 1408b) for performing a hybrid search of the knowledge probability graph 1410.

The result of the hybrid search is a candidate subgraph 1412 including two nodes 1414a,b. Node 1414a corresponds to a table listing different models of smartphones, shown as “Smartphones.” Node 1414b corresponds to a table of camera specifications that may include various attributes including resolution, shown as “Camera Specifications.” Assume that these tables are linked using a foreign key relationship such that smartphones in the “Smartphones” table having a particular camera component may be identified using the primary key of the camera component in the “Camera Specifications” table. This candidate subgraph 1412 may be selected due to the semantic similarities between the “Smartphones” and “Camera,” and “Resolution” keywords found in the CoT 1406 and nodes 1414b. Having selected this candidate subgraph 1412, the LLM 1404 may subsequently generate queries directed to the “Smartphones” and “Camera Specifications” table to provide, in response to the request 1402, a selection of “Smartphone” entries whose associated “Camera Specifications” listing includes a camera with at least 4K resolution.

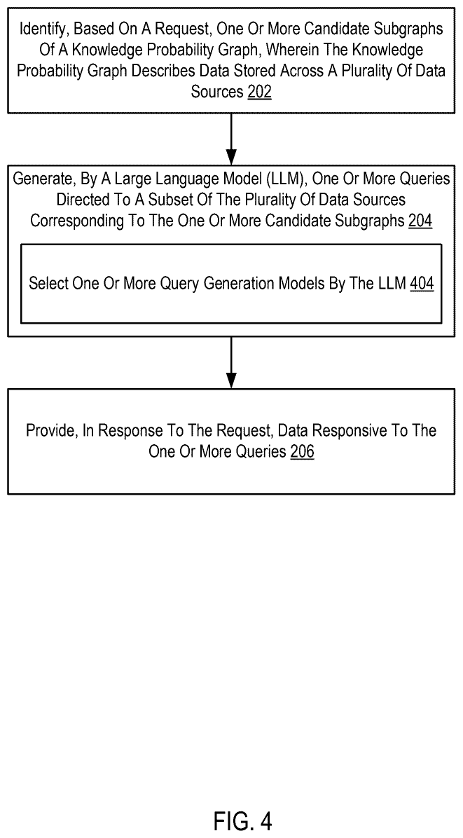

For further explanation, FIG. 4 sets forth a flowchart of an example method of querying multiple data sources using a knowledge probability graph and machine learning in accordance with some embodiments of the present disclosure. The method of FIG. 4 is similar to FIG. 2 in that the method of FIG. 4 also includes: identifying 202, based on a request, one or more candidate subgraphs of a knowledge probability graph, wherein the knowledge probability graph describes data stored across a plurality of data sources; generating 204, by a large language model (LLM), one or more queries directed to a subset of the plurality of data sources corresponding to the one or more candidate subgraphs; and providing 206, in response to the request, data responsive to the one or more queries.

The method of FIG. 4 differs from FIG. 2 in that generating 204, by a large language model (LLM), one or more queries directed to a subset of the plurality of data sources corresponding to the one or more candidate subgraphs also includes selecting 404 one or more query generation models by the LLM. In some embodiments, the one or more query generation models are trained models, including generative AI models or other models as can be appreciated, that accept natural language inputs and provide, as output, one or more queries based on the natural language input. In other words, the one or more query generation models may convert natural language descriptions of queries into queries of a particular format.

In some embodiments, the one or more query generation models may be selected from a plurality of query generation models. In some embodiments, each query generation model may correspond to a different type of query output, with each type of query output corresponding to a different type or implementation of a data source. For example, a first query generation model may convert natural language to SQL statements for databases, a second query generation model may convert natural language to a Hive request, and the like. Accordingly, in some embodiments, the one or more query generation models may be selected based on the particular type of data source to be queried in order to query the atomic data sources corresponding to the candidate subgraphs. Continuing with the example above, where a candidate subgraph includes atomic data sources (e.g., tables) from a database data source, the query generation model for converting natural language to SQL may be selected.

The LLM may then provide a natural language input to the selected query generation model(s) to generate one or more queries. In some embodiments, this natural language input may include natural language data generated by the LLM when processing the request. For example, the natural language input may be generated by the LLM based on the chain of thought described above for processing the request.

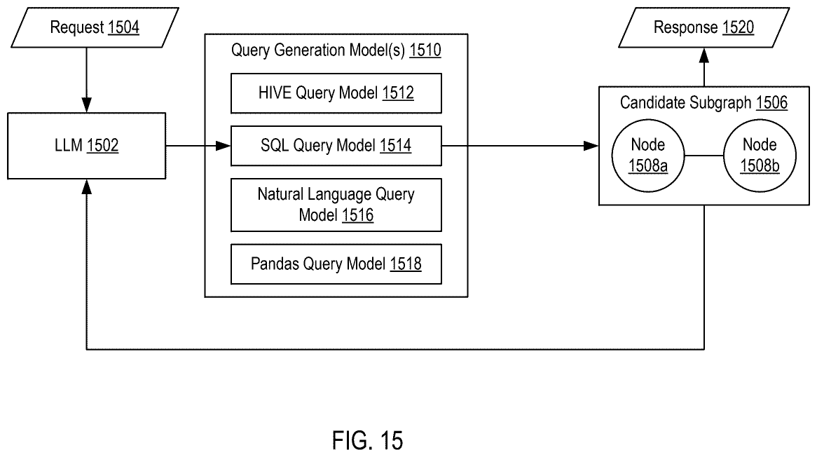

As an example, FIG. 15 shows a diagram of an example diagram of an exact query stage for querying multiple data sources using a knowledge probability graph and machine learning in accordance with some embodiments of the present disclosure. Here, assume that the LLM 1502 has received a request 1504 and identified a candidate subgraph 1506 (e.g., including nodes 1508a,b) using a hybrid search as described above. Using that candidate subgraph 1506, the LLM 1502 determines which of multiple query generation models 1510 is to be used to query the atomic data sources corresponding to the candidate subgraph 1506. For example, assume that the query generation models 1510 include a HIVE query model 1512 (e.g., for generating HIVE queries from natural language), an SQL query model 1514 (e.g., for generating SQL queries from natural language), a natural language query model 1516 (e.g., for generating natural language queries from other natural language inputs), and a Pandas query model 1518 (e.g., for generating Pandas queries from natural language).

Here, assume that the nodes 1508a,b correspond to SQL tables. Accordingly, the LLM 1502 determines that the SQL query model 1514 should be used to query these SQL tables and provides, to the SQL query model 1514, an input including or based on the request 1504. The SQL query model 1514 then converts this input into one or more SQL queries issued to the tables corresponding to the candidate subgraph 1506. The data returned in response to these queries is included in the response 1520.

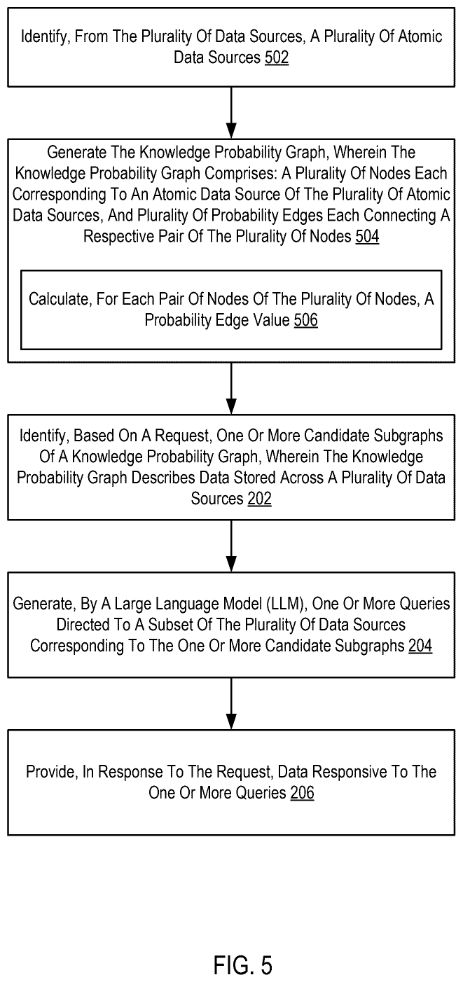

For further explanation, FIG. 5 sets forth a flowchart of an example method of querying multiple data sources using a knowledge probability graph and machine learning in accordance with some embodiments of the present disclosure. The method of FIG. 5 is similar to FIG. 2 in that the method of FIG. 5 also includes: identifying 202, based on a request, one or more candidate subgraphs of a knowledge probability graph, wherein the knowledge probability graph describes data stored across a plurality of data sources; generating 204, by a large language model (LLM), one or more queries directed to a subset of the plurality of data sources corresponding to the one or more candidate subgraphs; and providing 206, in response to the request, data responsive to the one or more queries.

The method of FIG. 5 sets forth approaches for generating the knowledge probability graph described above. The method of FIG. 5 differs from FIG. 2 in that the method of FIG. 5 also includes identifying 502, from the plurality of data sources, a plurality of atomic data sources. For example, in some embodiments, identifying 502 the plurality of atomic data sources may include crawling or traversing each of the plurality of data sources to identify the atomic data sources therein.

The method of FIG. 5 also includes generating 504 the knowledge probability graph, wherein the knowledge probability graph comprises: a plurality of nodes each corresponding to an atomic data source of the plurality of atomic data sources, and plurality of probability edges each connecting a respective pair of the plurality of nodes. In some embodiments, generating 504 the knowledge probability graph includes encoding, into the knowledge probability graph, a respective node for each of the identified atomic data sources. In some embodiments, encoding a particular node into the knowledge probability graph includes generating one or more features for the particular node.

As is set forth above, in some embodiments, the one or more features of the particular node may include metadata associated with the corresponding node, including column names or other schema attributes where applicable. In some embodiments, the one or more features may include semantic information (e.g., semantic features). Semantic information describes the data stored in the atomic data source corresponding to the particular node. In some embodiments, this semantic information may include a textual summary of the data stored in the atomic data source as generated by the LLM. In some embodiments, this textual summary may serve as a semantic index for the knowledge probability graph, such as when searching the knowledge probability graph for candidate subgraphs.

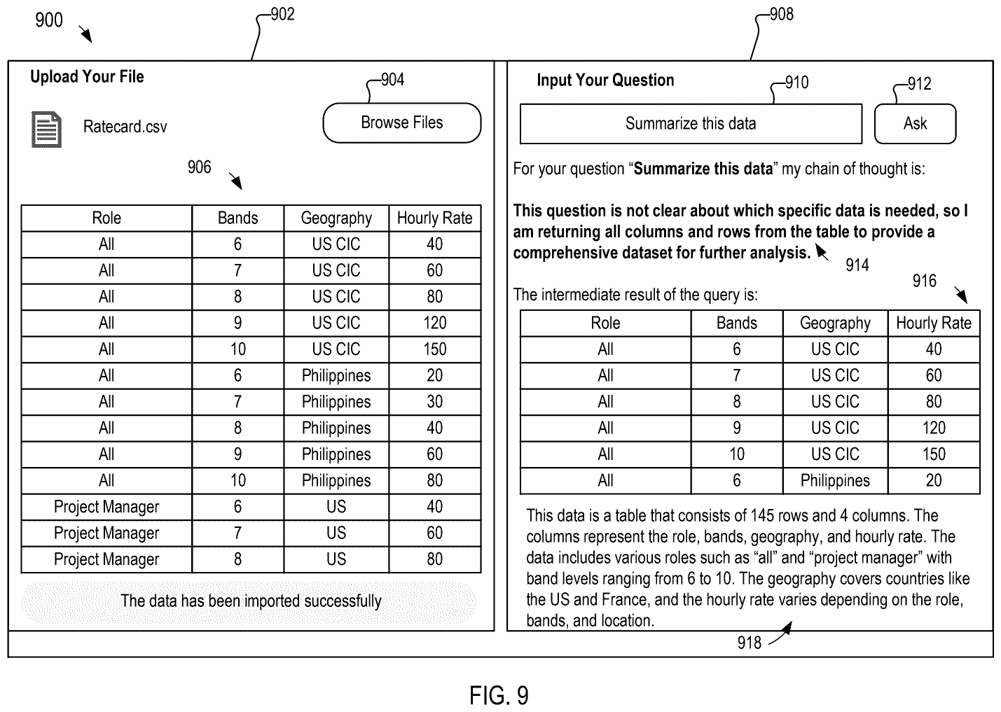

As an example, FIG. 9 shows an example user interface 900 for generating summaries of data. The example user interface 900 includes a frame 902 for uploading data to be summarized. The frame 902 includes a button 904 that, when selected, allows a user to browse for and select a file to be uploaded. A portion of the data included in the uploaded file is shown as table 906. The example user interface 900 also includes a frame 902 for a natural language interface for interacting with the uploaded data. The frame 908 includes a text input field 910 for natural language inputs to be processed by an LLM against the uploaded data and a button 912 that, when selected, provides the input of the text input field 910 to the LLM as a request. Here, the input to the text input field 910 requests the LLM to summarize the data. The frame 908 also includes a chain of thought 914 of the LLM when processing the request. Here, as the request was not a request for any specific portion of data, but rather a request for a summary, the LLM has returned the contents of the data, shown as table 916. The frame 908 also includes the summary 918 generated by the LLM.

Turning back to FIG. 5, in some embodiments, this semantic information may include a semantic expansion of structured fields associated with the atomic data source corresponding to the node. In some embodiments, these structured fields may include metadata fields. In some embodiments, such as where the atomic data source includes a database table, these metadata fields may include column names or other database fields. Semantic expansion converts an abbreviated field name into an expanded or full version of that abbreviated field name. For example, assuming a column name of “GEO,” semantic expansion may determine that this stands for “geography.” Accordingly, the term “geography” may be included in the semantic information for the node.

In some embodiments, semantic expansion may be performed by an LLM or another trained model as can be appreciated. In some embodiments, the LLM may accept, as input, the abbreviated field name and other contextual information to facilitate the semantic expansion. Such contextual information may include, for example, a data type for values of the field, specific values for the field, or other information as can be appreciated. Continuing with the example above, to perform semantic expansion of the column name “GEO,” the LLM may accept input indicating that the data type is a two-character string with example values of “CH,” “US,” and the like.

In some embodiments, generating 504 the knowledge probability graph includes encoding probability edges linking pairs of nodes. Each of these probability edges includes (e.g., as a feature) a probability edge value indicating a probability that the atomic data sources of the linked nodes are related. For example, the probability edge value may include a continuous value from zero to one, or another value as can be appreciated. Accordingly, in some embodiments, generating 504 the knowledge probability graph includes calculating 506, for each pair of nodes of the plurality of nodes, a probability edge value.

In some embodiments, the probability edge value for a given pair of nodes may be based on a semantic probability component and a logical probability component (e.g., a semantic probability and a logical probability). The semantic probability is a probability that the pair of nodes are related based on a similarity of their respective semantic information. The logical probability is a probability based on logical relationships between their respective metadata. In some embodiments, the probability edge value may be based on a count component (e.g., a “storage component”) indicating a number of connections between the pair of nodes in previous iterations of the knowledge probability graph (e.g., historical connectivity).

For example, in some embodiments, the probability edge value P linking two nodes may be calculated as P=α*(P_{semantics}+P_{logical})+sigmoid(count), where α is a tunable experience value, P_{semantics} is the semantic probability, P_{logical} is the logical probability, and sigmoid(count)=1/(1+e^{-k*count}), with k as a scaling factor that determines how fast the sigmoid function saturates. Specific approaches for calculating P_{semantics} and P_{logical} are described in further detail below. As is set forth above, in some embodiments, the probability edge value between two nodes may be calculated as a value between zero and one. Accordingly, in some embodiments, where the calculated probability edge value is equal to zero for a given pair of nodes, there would be no edge linking the given pair of nodes. In other words, in some embodiments, where a calculated probability edge value for a given pair of nodes is equal to zero, those nodes will not have a direct edge connection in the knowledge probability graph.

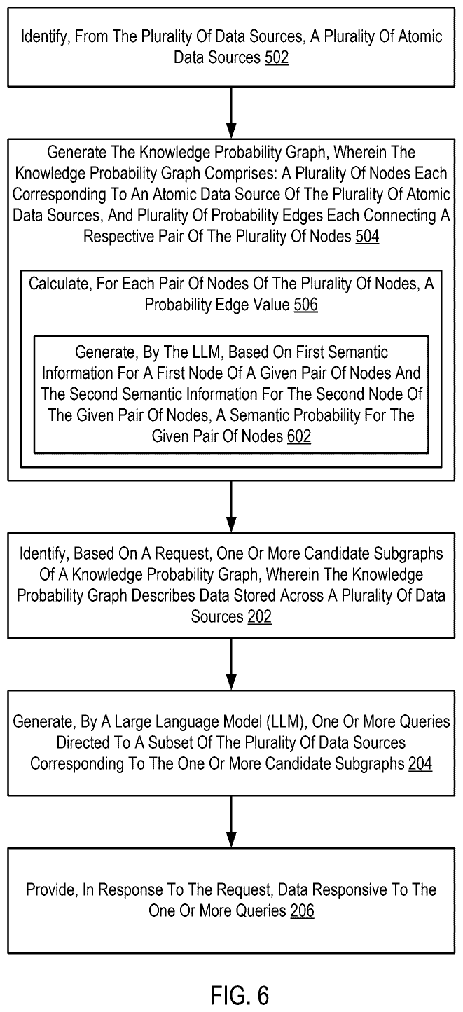

For further explanation, FIG. 6 sets forth a flowchart of an example method of querying multiple data sources using a knowledge probability graph and machine learning in accordance with some embodiments of the present disclosure. The method of FIG. 6 is similar to FIG. 5 in that the method of FIG. 6 also includes: identifying 502, from the plurality of data sources, a plurality of atomic data sources; identifying 202, based on a request, one or more candidate subgraphs of a knowledge probability graph, wherein the knowledge probability graph describes data stored across a plurality of data sources; generating 504 the knowledge probability graph, wherein the knowledge probability graph comprises: a plurality of nodes each corresponding to an atomic data source of the plurality of atomic data sources, and plurality of probability edges each connecting a respective pair of the plurality of nodes, including: calculating 506, for each pair of nodes of the plurality of nodes, a probability edge value; generating 204, by a large language model (LLM), one or more queries directed to a subset of the plurality of data sources corresponding to the one or more candidate subgraphs; and providing 206, in response to the request, data responsive to the one or more queries.

The method of FIG. 6 differs from FIG. 5 in that calculating 506, for each pair of nodes of the plurality of nodes, a probability edge value includes generating 602, by the LLM, based on first semantic information for a first node of a given pair of nodes and the second semantic information for the second node of the given pair of nodes, the semantic probability for the given pair of nodes. For example, in some embodiments, the LLM may be provided semantic information for each node of the given pair of nodes as part of a prompt instructing the LLM to provide, as output, the semantic probability. Such semantic information may include, for example, a textual summary of the corresponding atomic data source, a semantic expansion of metadata, and the like. In some embodiments, the semantic probability may be expressed as a continuous value from zero to one. Accordingly, in some embodiments, the semantic probability may be calculated as P_{semantics}=LLMsimilarity(f₁, f₂), where f₁ is the semantic information for a first node and f₂ is the semantic information for the second node.

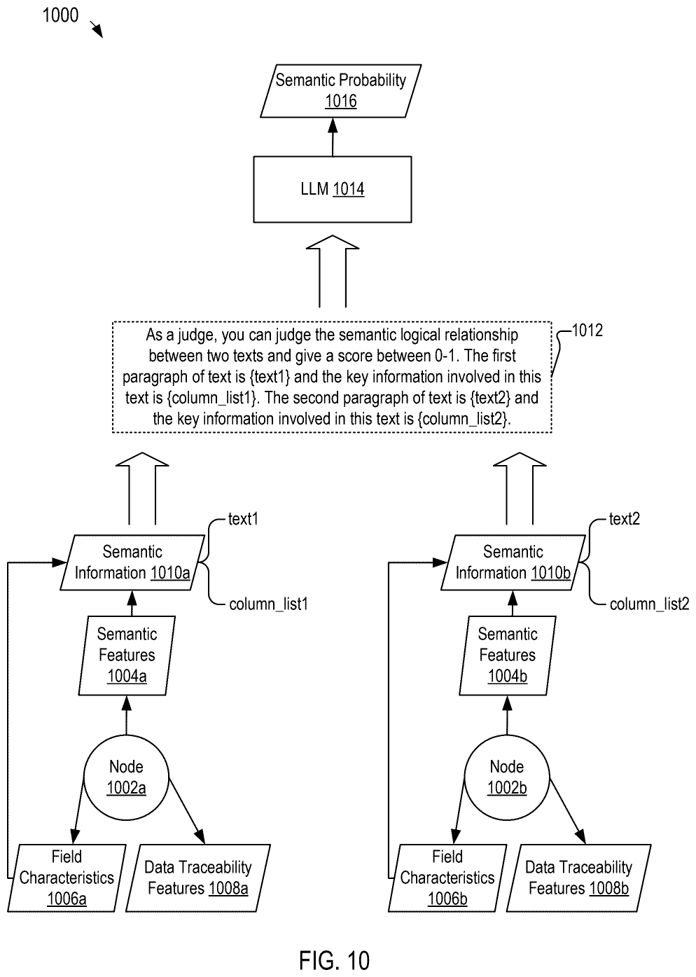

As an example, FIG. 10 sets forth an example diagram 1000 for calculating the semantic probability that data sources respectively represented by a pair of nodes are related to each other in accordance with some embodiments of the present disclosure. The diagram 1000 includes node 1002a and node 1002b each having their own semantic features 1004a,b, field characteristics 1006a,b, and data traceability features 1008a, b as described above. Here, for each node 1002a,b, their semantic features 1004a,b (e.g., a summary of their underlying data) are included in their semantic information 1010a,b, shown as “text1” or “text2,” respectively. Additionally, for each node 1002a,b, a semantic expansion of their field characteristics 1006a,b, such as semantic expansions of column names or metadata fields, are also included in their semantic information 1010a, b, shown as “column_list1” and “column_list2,” respectively. The particular values of the semantic information 1010a,b (e.g., “text1,” “text2,” “column_list1,” and “column_list2”) are used to populate the matching placeholder elements of a prompt 1012 to the LLM 1014. Here, the prompt 1012 being input into the LLM 1014 causes the LLM 1014 to produce and provide, as output, a semantic probability 1016 between zero and one that the data sources represented by the Nodes 1002a and 1002b are related to each other.

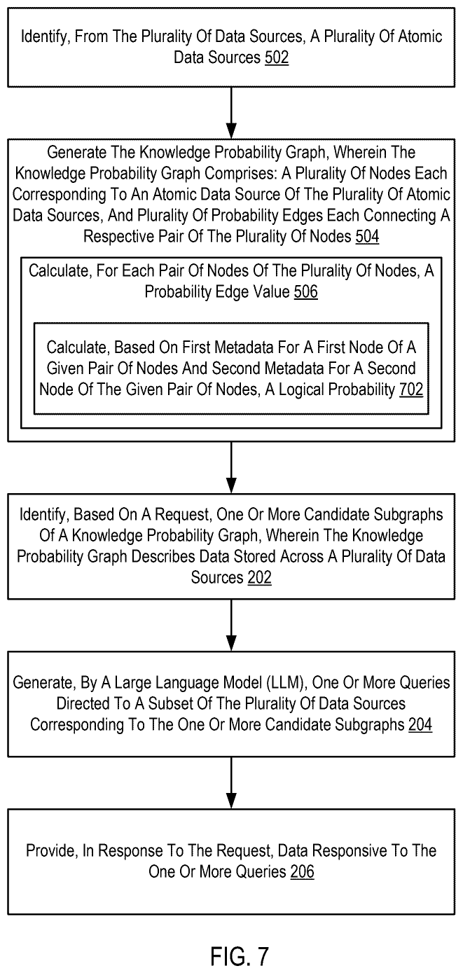

For further explanation, FIG. 7 sets forth a flowchart of an example method of querying multiple data sources using a knowledge probability graph and machine learning in accordance with some embodiments of the present disclosure. The method of FIG. 7 is similar to FIG. 5 in that the method of FIG. 7 also includes: identifying 502, from the plurality of data sources, a plurality of atomic data sources; identifying 202, based on a request, one or more candidate subgraphs of a knowledge probability graph, wherein the knowledge probability graph describes data stored across a plurality of data sources; generating 504 the knowledge probability graph, wherein the knowledge probability graph comprises: a plurality of nodes each corresponding to an atomic data source of the plurality of atomic data sources, and plurality of probability edges each connecting a respective pair of the plurality of nodes, including: calculating 506, for each pair of nodes of the plurality of nodes, a probability edge value; generating 204, by a large language model (LLM), one or more queries directed to a subset of the plurality of data sources corresponding to the one or more candidate subgraphs; and proiding 206, in response to the request, data responsive to the one or more queries.

The method of FIG. 7 differs from FIG. 5 in that calculating 506, for each pair of nodes of the plurality of nodes, a probability edge value includes calculating 702, based on first metadata for a first node of a given pair of nodes and second metadata for a second node of the given pair of nodes, a logical probability. In some embodiments, calculating 702 the logical probability may be based on an explicit or an implicit relationship between the first metadata and the second metadata. In other words, the logical probability may be based on the sum of an explicit score representing explicit relationships and an implicit score representing implicit relationships.

For example, in some embodiments, an explicit relationship may be present in the first metadata and the second metadata where there is a primary or foreign key relationship present, such as where the first node and the second node correspond to tables of the same database. If such an explicit relationship is found, the explicit score is set to one. Otherwise, the explicit score is set to zero.

As another example, an implicit relationship may be based on a similarity between semantic expansions of the first and second metadata. Accordingly, the implicit score may be calculated as a function of a semantic similarity and/or edit distance between the semantic expansions of the first and second metadata. In some embodiments, the implicit score may also be calculated as a function of the semantic similarity and/or edit distance between the grouped, sorted, and deduplicated values of the first and second metadata. Thus, the logical probability P_{logical} may be calculated as P_{logical}=min(implicit_score+explicit_score,1) such that P_{logical} does not exceed one.

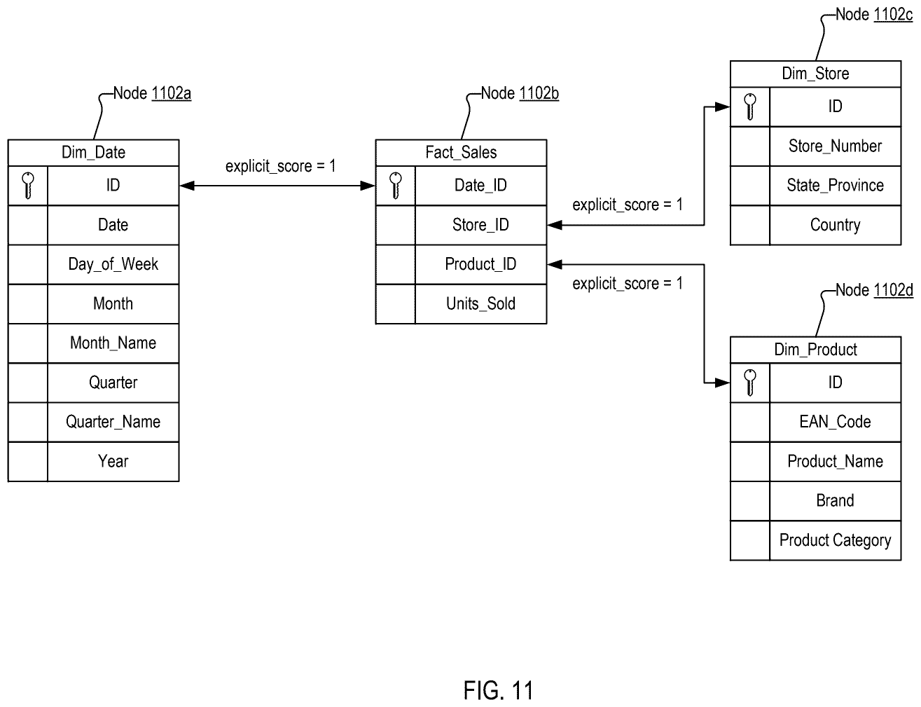

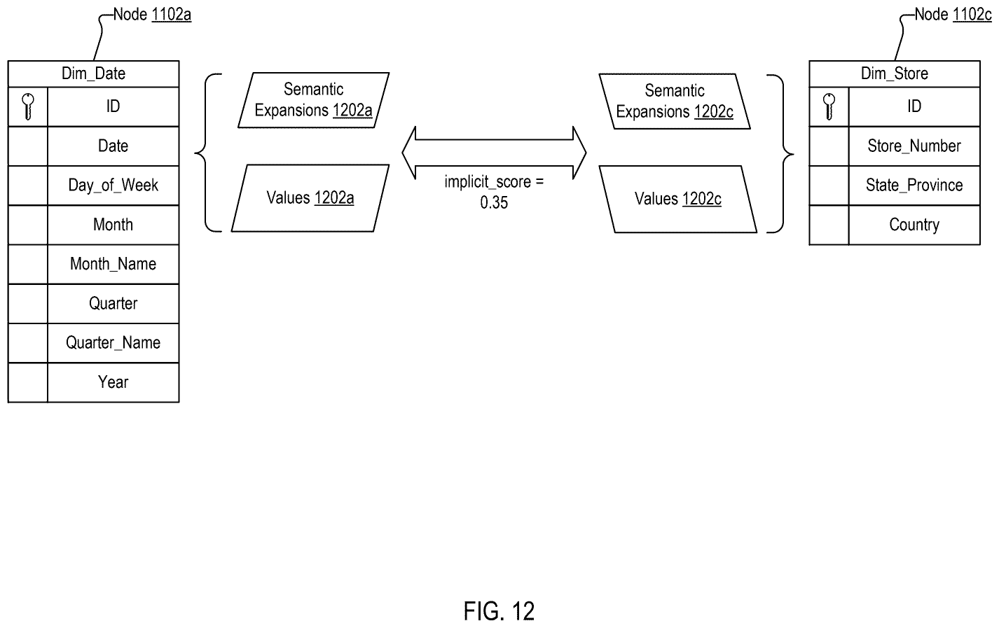

For example, FIGS. 11 and 12 show example diagrams for determining explicit and implicit scores for relationships between nodes of a knowledge probability graph in accordance with some embodiments of the present disclosure. Beginning with FIG. 11, shown are nodes 1102a,b,c,d each corresponding to a different table. Here, node 1102a corresponds to a table “Dim_Date” with a field “ID” serving as a primary key. Node 1102b corresponds to a table “Fact_Sales” with a field “Date_ID” having a foreign key relationship with the “ID” field of node 1102a. Accordingly, the explicit score for nodes 1102a and 1102b is one due to this foreign key relationship. Node 1102c corresponds to a table “Dim_Store” with a field “ID” having a foreign key relationship with the “Date_ID” field of node 1102b. Accordingly, the explicit score for nodes 1102b and 1102c is one due to this foreign key relationship. Node 1102d corresponds to a table “Dim_Product” with a field “ID” having a foreign key relationship with the “Product_ID” field of node 1102b. Accordingly, the explicit score for nodes 1102b and 1102d is one due to this foreign key relationship. In this example, the explicit score between any other pairing of nodes 1102a,b,c,d not described above would be set to zero.

FIG. 12 includes nodes 1102a and 1102c as shown in FIG. 11, the pair of which had an explicit score of zero. To calculate the implicit score for nodes 1102a,c, a semantic expansion is applied to the metadata fields of the respective nodes 1102a,c to generate semantic expansions 1202a,c. Additionally, the metadata values for each node 1102a,c are grouped by column name, sorted, and deduplicated to values 1204a,c. The implicit score may be calculated as a function of a semantic similarity and/or edit distance between the respective semantic expansions 1202a,c and values 1202a,c.

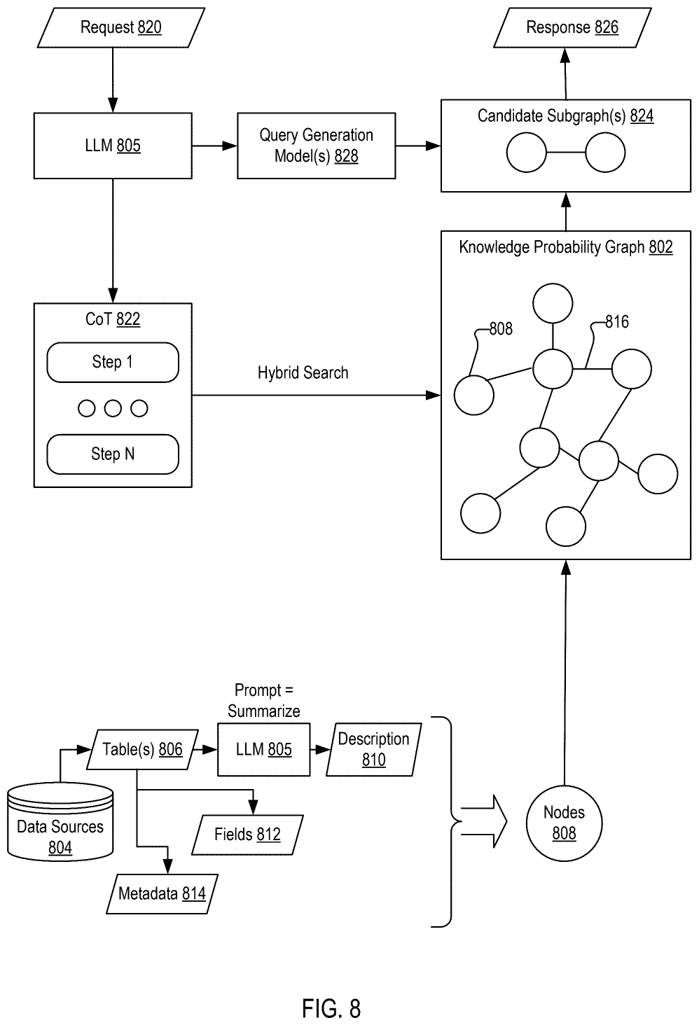

FIG. 8 sets forth an example flow diagram for querying multiple data sources using a knowledge probability graph and machine learning in accordance with some embodiments of the present disclosure. To begin, in order to generate a knowledge probability graph 802, atomic data sources are identified from multiple heterogeneous data sources 804. Such atomic data sources include tables 806 and may also include other atomic data sources as can be appreciated. Each of these atomic data sources may then be encoded as a respective node 808 in the knowledge probability graph 802.

For example, to generate a node 808 from a table 806, the LLM 805 generates a description 810 of the table 806 by prompting the LLM 805 to generate, as the description 810, a summary of the data included in the table. This textual description may then be encoded as a semantic feature of the corresponding node 808. As another example, structured fields from the table 806 including column names, shown as fields 812, and metadata 814 fields may be encoded as field characteristics of the node 808. As a further example, the data stored in the table 806 itself may be encoded as data traceability features of the node 808.

After generating multiple nodes 808 from the atomic data sources of the data sources 804, the knowledge probability graph 802 is generated by calculating probability edge values for edges 816 reflecting a degree to which a given pair of nodes 808 are related. This may be performed using similar approaches as are set forth above, including being based on explicit or implicit relationships between the atomic data sources corresponding to the pair of nodes 808. The resulting collection of nodes 808 linked by edges 816 having probability edge values forms the knowledge probability graph 802.

The generated knowledge probability graph 802 may then be used to service requests 820. For example, a request 820 such as a natural language expression may be provided as input to the LLM 805 for processing. To process the request 820, the LLM 805 performs a query including a recall stage and an exact query stage. The recall stage includes identifying the candidate subgraphs 824 whose atomic data sources will be queried for data included in the response 826. To perform this recall stage, the LLM 805 provides, as output, a chain of thought (CoT) 822 including a step-by-step description of how the LLM 805 processed or interpreted the request 820. The CoT 822 may then be used to perform a hybrid search of the knowledge probability graph 802 (e.g., a search based on a combination of semantic matching and graph structure matching between the CoT 822 and the knowledge probability graph 802) to identify one or more candidate subgraphs 824.

To perform the exact query stage, the atomic data sources corresponding to the nodes 808 of the identified candidate subgraphs 824 are issued one or more queries. In order to query these atomic data sources, the LLM 805 determines the particular type of queries to be issued to the atomic data sources (e.g., SQL queries, Pandas queries, natural language queries, etc.). For example, an atomic data source for a table in an SQL database may be issued an SQL query while an atomic data source including Pandas data frames may be issued a Pandas query. Accordingly, the LLM 805 determines the particular types of queries to be issued to these atomic data sources and selects the appropriate query generation models 828 to convert a natural language expression from the LLM 805 (e.g., the request 820 or based on the request 820) into the queries to be issued to the atomic data sources. The data returned in response to these issued queries are included in the response 826 to an issuer of the request 820.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying, based on a request, one or more candidate subgraphs of a knowledge probability graph, wherein the knowledge probability graph describes data stored across multiple data sources;
generating, by a machine learning model, one or more queries directed to a subset of the multiple data sources corresponding to the one or more candidate subgraphs, the machine learning model having been trained for natural language generative tasks; and
providing, in response to the request, data responsive to the one or more queries, wherein the providing is based on a retrieval from the subset of the multiple data sources.

2. The method of claim 1, wherein the multiple data sources each comprise one or more atomic data sources and wherein the knowledge probability graph comprises multiple nodes each corresponding to a respective atomic data source of the multiple data sources.

3. The method of claim 1, wherein the identifying the one or more candidate subgraphs comprises:
generating, by the machine learning model, a chain of thought for processing the request;
generating, based on the chain of thought, a sequential graph; and
identifying, from the knowledge probability graph, the one or more candidate subgraphs based on a graph structure matching applied to the sequential graph and a semantic matching applied to the sequential graph.

4. The method of claim 1, wherein generating, by the machine learning model, the one or more queries comprises selecting one or more query generation models by the machine learning model.

5. The method of claim 1, further comprising:
identifying, from the multiple data sources, multiple atomic data sources; and
generating the knowledge probability graph, wherein the knowledge probability graph comprises: multiple nodes each corresponding to an atomic data source of the multiple atomic data sources, and multiple probability edges each connecting a respective pair of the multiple nodes.

6. The method of claim 5, wherein the generating the knowledge probability graph comprises calculating, for each pair of nodes of the multiple nodes, a probability edge value indicating whether a first node and a second node of the pair of nodes are related to each other, wherein the probability edge value for a given pair of nodes is based on a semantic probability that the first node and the second node of the given pair of nodes are related to each other and a logical probability that the first node and the second node of the given pair of nodes are related to each other.

7. The method of claim 6, wherein the calculating the probability edge value comprises generating, by the machine learning model, based on first semantic information for a first node of the given pair of nodes and second semantic information for the second node of the given pair of nodes, the semantic probability that the first node and the second node of the given pair of nodes are related to each other.

8. The method of claim 6, wherein the calculating the probability edge value comprises calculating, based on first metadata for a first node of the given pair of nodes and second metadata for a second node of the given pair of nodes, the logical probability that the first node and the second node of the given pair of nodes are related to each other.

9. The method of claim 8, wherein the logical probability is based on an explicit relationship between the first metadata and the second metadata.

10. The method of claim 8, wherein the logical probability is based on an implicit relationship based on a semantic extension of the first metadata and another semantic extension of the second metadata.

11. A computer system comprising:
one or more computer-readable storage media;
a processor set; and
program instructions stored on the one or more storage media to cause the processor set to perform operations comprising:
identifying, based on a request, one or more candidate subgraphs of a knowledge probability graph, wherein the knowledge probability graph describes data stored across multiple data sources;
generating, by a machine learning model, one or more queries directed to a subset of the multiple data sources corresponding to the one or more candidate subgraphs, the machine learning model having been trained for natural language generative tasks; and
providing, in response to the request, data responsive to the one or more queries, wherein the providing is based on a retrieval from the subset of the multiple data sources.

12. The computer system of claim 11, wherein the multiple data sources each comprise one or more atomic data sources and wherein the knowledge probability graph comprises multiple nodes each corresponding to a respective atomic data source of the multiple data sources.

13. The computer system of claim 11, wherein the identifying the one or more candidate subgraphs comprises:
generating, by the machine learning model, a chain of thought for processing the request;
generating, based on the chain of thought, a sequential graph; and
identifying, from the knowledge probability graph, the one or more candidate subgraphs based on a graph structure matching applied to the sequential graph and a semantic matching applied to the sequential graph.

14. The computer system of claim 11, wherein generating, by the machine learning model, the one or more queries comprises selecting one or more query generation models by the machine learning model.

15. The computer system of claim 11, wherein the operations further comprise:
identifying, from the multiple data sources, multiple atomic data sources; and
generating the knowledge probability graph, wherein the knowledge probability graph comprises: multiple nodes each corresponding to an atomic data source of the multiple atomic data sources, and multiple probability edges each connecting a respective pair of the multiple nodes.

16. The computer system of claim 15, wherein the generating the knowledge probability graph comprises calculating, for each pair of nodes of the multiple nodes, a probability edge value indicating whether a first node and a second node of the pair of nodes are related to each other, wherein the probability edge value for a given pair of nodes is based on a semantic probability that the first node and the second node of the given pair of nodes are related to each other and a logical probability that the first node and the second node of the given pair of nodes are related to each other.

17. The computer system of claim 16, wherein the calculating the probability edge value comprises generating, by the machine learning model, based on first semantic information for a first node of the given pair of nodes and second semantic information for the second node of the given pair of nodes, the semantic probability that the first node and the second node of the given pair of nodes are related to each other.

18. The computer system of claim 16, wherein the calculating the probability edge value comprises calculating, based on first metadata for a first node of the given pair of nodes and second metadata for a second node of the given pair of nodes, the logical probability that the first node and the second node of the given pair of nodes are related to each other.

19. The computer system of claim 18, wherein the logical probability is based on an explicit relationship between the first metadata and the second metadata.

20. A computer program product comprising:
one or more computer-readable storage media; and
program instructions stored on the one or more storage media to perform operations comprising:
identifying, based on a request, one or more candidate subgraphs of a knowledge probability graph, wherein the knowledge probability graph describes data stored across multiple data sources;
generating, by a machine learning model, one or more queries directed to a subset of the multiple data sources corresponding to the one or more candidate subgraphs, the machine learning model having been trained for natural language generative tasks; and
providing, in response to the request, data responsive to the one or more queries, wherein the providing is based on a retrieval from the subset of the multiple data sources.
